(19) United States
(12) Patent Application Publication
(10) Pub. No.: US 2018/0059978 A1
(43) Pub. Date: Mar. 1, 2018

(54) VIRTUAL DISK EXPANSION METHOD AND APPARATUS

(71) Applicant: ALIBABA GROUP HOLDING LIMITED, George Town (KY)

(72) Inventor: Lei PENG, Hangzhou (CN)

(73) Assignee: ALIBABA GROUP HOLDING LIMITED

(21) Appl. No.: 15/691,658

(22) Filed: Aug. 30, 2017

(30) Foreign Application Priority Data
Aug. 30, 2016 (CN) 201610766855.4

(51) Int. Cl. G06F 3/06

(52) U.S. Cl. CPC G06F 3/0626; G06F 3/0689; G06F 3/0644; G06F 3/0665; G06F 3/0619

(57) ABSTRACT

A virtual disk expansion method is disclosed in the present application, comprising: creating a virtual disk file according to system images and a target disk volume value contained in a received expansion request; mounting the virtual disk file to a physical host, and generating a virtual disk; reading partition information of the virtual disk; deleting a partition to be expanded of the virtual disk and creating a new partition according to a partition volume value of the partition to be expanded and an expansion value; and reading a file system of the virtual disk and expanding the file system to be adapted to the new partition. The virtual disk expansion method is realized based on a physical host, shortens the I/O path and improves the I/O efficiency; also, during the virtual disk expansion process, there is no need to start a virtual machine on the physical host and the expansion is performed before the start of the virtual machine, thereby reducing technical complexity and coupling.

### CROSS REFERENCE TO RELATED APPLICATION

The disclosure claims the benefits of priority to Chinese Application No. 201610766855.4, filed Aug. 30, 2016, which is incorporated herein in its entirety.

### TECHNICAL FIELD

The present disclosure relates to the technical field of virtualization, and in particular to a virtual disk expansion method. Further, the present disclosure relates to a virtual disk expansion apparatus and an electronic device.

### BACKGROUND

In an elastic compute cloud, a cloud provider provides a plurality of system images for various operating system platforms. In actual applications, the provided system images are used for creating virtual disks and virtual machines (VMs). And in the end, an operating system (e.g., a GuestOS) is loaded to the virtual machine. To the cloud provider, the range of volume values of the virtual disk is quite large. For example, a virtual disk may contain 100 Gigabyte (G) units to 10 Terabyte (T) units, and even 100 T units. But the number of system images provided by the cloud provider is limited, and therefore the volume value of the virtual disks created based on these system images is also limited. And the cloud provider can only provide one or more system images with a fixed volume value. In actual applications, however, users have different service demands, and may choose different operating systems or virtual machines with different configurations (e.g., virtual disks with different volume values). These different configurations can impose a higher requirement on the cloud provider. For example, when the volume value of a virtual disk chosen by a user is greater than the volume value of a virtual disk provided by the cloud provider, the virtual disk can be expanded to meet the user's demand.

According to one technique, the expansion of virtual disks is realized by using a tool library (e.g., Libguestfs), which accesses and modifies system images corresponding to a virtual disk of a virtual machine. For example, when a user chooses a volume larger than that of a virtual disk created based on the system images, a virtual disk is created based on system images with a fixed volume provided by the cloud provider. After the virtual disk is created, a virtual machine is started, and Libguestfs-based services are then operated within the virtual machine. An expansion request of the user is sent in a socket manner from a physical host to an operating system running on the virtual machine. Virtual disk partitioning and file system expanding are performed in the operating system, so as to achieve the expansion of the virtual disk.

However, the above-mentioned virtual disk expansion method has low feasibility and high technical complexity.

### SUMMARY

Embodiments of the present disclosure provide a virtual disk expansion method, so as to address the problems of low feasibility and high technical complexity.

Also, embodiments of the present disclosure provide a virtual disk expansion apparatus and an electronic device.

Embodiments of the present disclosure provide a virtual disk expansion method, comprising: creating a virtual disk file according to pre-set system images and a target disk volume value contained in a received expansion request; mounting the virtual disk file to a physical host, and generating a virtual disk corresponding to the virtual disk file; reading partition information of the virtual disk; deleting a partition to be expanded of the virtual disk and creating a new partition according to a partition volume value of the partition to be expanded and an expansion value; and reading a file system of the virtual disk and expanding the file system to be adapted to the new partition.

In some embodiments, the virtual disk expansion method further comprises: receiving the expansion request.

In some embodiments, the virtual disk expansion method further comprises: choosing system images matching the expansion request from the pre-set system images according to the expansion request.

In some embodiments, the expansion request contains an operating system type, and the system images matching the expansion request comprise: system images having the operating system type.

In some embodiments, the system images matching the expansion request comprise: system images having a volume value of the virtual disk smaller than the target disk volume value, or system images having a difference value between the volume value of the virtual disk and the target disk volume value being within a pre-set threshold range.

In some embodiments, the mounting the virtual disk file to a physical host is realized by calling a mounting interface, wherein the mounting interface is provided by a software development kit (SDK), and respective mounting tools of virtualization platforms encapsulated by the SDK are used via the mounting interface for mounting the virtual disk file, the virtualization platforms comprising: Xen and KVM.

In some embodiments, the virtual disk expansion method further comprises: calling a cleaning interface to clean the virtual disk, wherein the cleaning interface is provided by the SDK, and respective cleaning tools of the virtualization platforms encapsulated by the SDK are used via the cleaning interface for cleaning the virtual disk.

In some embodiments, reading partition information of the virtual disk further comprises: calling a partition acquisition interface to acquire partition information recorded in the virtual disk file to be taken as partition information of the virtual disk, wherein the partition acquisition interface is provided by an SDK, and a partition information acquisition command provided by a partition tool encapsulated by the SDK is used via the partition acquisition interface.

In some embodiments, the partition information comprises: at least one of the number of partitions, a partition identifier, start sector position information, end sector position information, a flag, and a partition type.

In some embodiments, the expansion value is a difference value between the target disk volume value and a disk volume value of the virtual disk created according to the system images.

In some embodiments, the partition volume value is obtained according to the start sector position information and the end sector position information.

In some embodiments, the virtual disk expansion method further comprises: determining, according to the partition information, whether partitions of the virtual disk satisfy an expansion condition, and if the partitions of the virtual disk satisfy the expansion condition, executing the next step.

In some embodiments, the expansion condition comprises: the partition volume value of the partition to be expanded being greater than or equal to the target disk volume value, and/or the partition type of the virtual disk supporting expansion.

In some embodiments, deleting a partition to be expanded of the virtual disk and creating a new partition according to a partition volume value of the partition to be expanded and an expansion value comprises: choosing the partition to be expanded from partitions of the virtual disk, and storing partition information corresponding to the partition to be expanded; deleting the partition to be expanded; creating the new partition according to the stored partition information, the partition volume value of the partition to be expanded, and the expansion value; and setting the new partition according to the stored partition information.

In some embodiments, a partition identifier of the partition to be expanded is consistent with a partition identifier, a flag, and/or a partition type of the new partition.

In some embodiments, start sector position information of the partition to be expanded is consistent with start sector position information of the new partition; and end sector position information of the new partition is obtained according to the start sector position information of the partition to be expanded and the expansion value.

In some embodiments, deleting the partition to be expanded further comprises: calling a partition deleting interface to delete the partition to be expanded from the virtual disk file, wherein the partition deleting interface is provided by the SDK, and a partition deleting command provided by the partition tool is used via the partition deleting interface.

In some embodiments, creating the new partition further comprises: calling a pre-set partition creating interface to create the new partition in the virtual disk file, wherein the partition creating interface is provided by the SDK, and a partition creating command provided by the partition tool is used via the partition creating interface.

In some embodiments, setting the new partition according to the stored partition information further comprises: calling a pre-set partition setting interface to set the new partition in the virtual disk file according to the stored partition information, wherein the partition setting interface is provided by the SDK, and a partition setting command provided by the partition tool is used via the partition setting interface.

In some embodiments, reading a file system of the virtual disk and expanding the file system to be adapted to the new partition further comprises: reading a file system of the virtual disk from the system images; and calling a file system expansion interface to expand the file system according to the new partition, wherein the file system expansion interface is provided by the SDK, and an expansion tool of a file system tool set encapsulated by the SDK is used via the file system expansion interface.

In some embodiments, the virtual disk expansion method further comprises: calling, according to a partition type of the partition to be expanded, a file system check interface to check whether the file system is valid, and if the file system is valid, executing the next step, wherein the file system check interface is provided by the SDK, and a check tool of a file system tool set encapsulated by the SDK is used via the file system check interface.

In some embodiments, if the file system is not valid, the virtual disk expansion method further comprises: calling a file system repairing interface to repair the file system; and calling, according to a partition type of the partition to be expanded, the file system check interface to check whether the file system is repaired, and if the file system is repaired, calling a file system expansion interface to expand the file system according to the new partition, wherein the file system repairing interface is provided by the SDK, and a repairing tool of a file system tool set encapsulated by the SDK is used via the file system repairing interface.

In some embodiments, after the sub-step of calling a file system expansion interface to expand the file system according to the new partition is executed, the virtual disk expansion method further comprises: calling, according to a partition type of the partition to be expanded, the file system check interface to check whether the file system is valid, and if the file system is not valid, sending reminding information of expansion failure.

Embodiments of the present disclosure further provides a virtual disk expansion apparatus, comprising: a virtual disk file creating unit, for creating a virtual disk file according to pre-set system images and a target disk volume value contained in a received expansion request; virtual disk generating unit, for mounting the virtual disk file to a physical host, and generating a corresponding virtual disk; a partition information reading unit, for reading partition information of the virtual disk; a partition expanding unit, for deleting a partition to be expanded of the virtual disk and creating a new partition according to a partition volume value of the partition to be expanded and an expansion value; and a file system expanding unit, for reading a file system of the virtual disk and expanding the file system to be adapted to the new partition.

Optionally, the virtual disk expansion apparatus comprises: an expansion request receiving unit, for receiving the expansion request.

Optionally, the virtual disk expansion apparatus comprises: a system image choosing unit, for choosing system ages matching the expansion request from the pre-set system images according to the expansion request.

Optionally, the virtual disk generating unit is realized by calling a pre-set mounting interface, wherein the mounting interface is provided by a pre-set SDK, and a respective mounting tool, for achieving the mounting of a virtual disk file, of virtualization platforms encapsulated by the SDK is used via the mounting interface, the virtualization platforms comprising: Xen and KVM.

Optionally, the virtual disk expansion apparatus comprises: a virtual disk cleaning unit, for calling a pre-set cleaning interface to clean the virtual disk, wherein the cleaning interface is provided by the SDK, and a respective cleaning tool, for cleaning the virtual disk, of the virtualization platforms encapsulated by the SDK is used via the cleaning interface.

Optionally, the partition information reading unit is further used for calling a pre-set partition acquisition interface to acquire partition information recorded in the virtual disk file to be taken as partition information of the virtual disk, wherein the partition acquisition interface is provided by a pre-set SDK, and a partition information acquisition command provided by a partition tool encapsulated by the SDK is used via the partition acquisition interface.

Optionally, the partition information comprises: the number of partitions, a partition identifier, start sector position information, end sector position information, a flag, and a partition type.

Optionally, the virtual disk expansion apparatus comprises: an expansion determining unit, for determining, according to the partition information, whether partitions of the virtual disk satisfy an expansion condition, and if the partitions of the virtual disk satisfy the expansion condition, running the partition expanding unit.

Optionally, the partition expanding unit comprises: a partition to be expanded choosing sub-unit, for choosing the partition to be expanded from partitions of the virtual disk, and storing partition information corresponding to the partition to be expanded; a partition to be expanded deleting sub-unit, for deleting the partition to be expanded; a new partition creating sub-unit, for creating the new partition according to the stored partition information, the partition volume value of the partition to be expanded and the expansion value; and a new partition setting sub-unit, for setting the new partition according to the stored partition information.

Optionally, the file system expanding unit comprises: a file system reading sub-unit, for reading a file system of the virtual disk from the system images; and a file system expanding sub-unit, for calling a pre-set file system expansion interface to expand the file system according to the new partition, wherein the file system expansion interface is provided by the SDK, and an expansion tool of a file system tool set encapsulated by the SDK is used via the file system expansion interface.

Optionally, the file system expanding unit further comprises: a file system checking sub-unit, for calling, with reference to a partition type of the partition to be expanded, a pre-set file system check interface to check whether the file system is valid, and if the file system is valid, running the file system expanding sub-unit, wherein the file system check interface is provided by the SDK, and a check tool of a file system tool set encapsulated by the SDK is used via the file system check interface.

The present disclosure further provides an electronic device, comprising: a processor and a memory, wherein the processor is used for creating a virtual disk file according to pre-set system images and a target disk volume value contained in a received expansion request; mounting the virtual disk file to a physical host, and generating a virtual disk; reading partition information of the virtual disk; deleting a partition to be expanded of the virtual disk and creating a new partition according to a partition volume value of the partition to be expanded and an expansion value; and reading a file system of the virtual disk and expanding the file system to be adapted to the new partition; and the memory is used for storing the virtual disk file, the partition information of the virtual disk and the file system of the virtual disk.

Embodiments of the disclosure can realize the virtual disk expansion method directly based on a physical host for the virtual disk expansion. Therefore, the I/O path can be shortened, the consumption of the I/O path can be reduced, and the I/O efficiency can be improved. In addition, with regard to the virtual disk expansion method, during a virtual disk expansion process, there is no need to start a virtual machine on the physical host and the expansion to the virtual disk is performed before the start of the virtual machine, thereby reducing technical complexity and coupling. The implementation of the method is quite simple.

### BRIEF DESCRIPTION OF THE DRAWINGS

FIG. 1 is a flow chart of an exemplary virtual disk expansion method, according to embodiments of the present disclosure.

FIG. 2 is a schematic view of an exemplary software storage system, according to embodiments of the present disclosure.

FIG. 3 is a schematic view of an exemplary virtual disk expansion apparatus, according to embodiments of the present disclosure.

FIG. 4 is a schematic view of an exemplary electronic device, according to embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

Embodiments of the present disclosure provide a virtual disk expansion method, and further provide a virtual disk expansion apparatus and an electronic device. Detailed description is provided below in conjunction with the figures of embodiments provided by the present disclosure, and various steps of the method are also described.

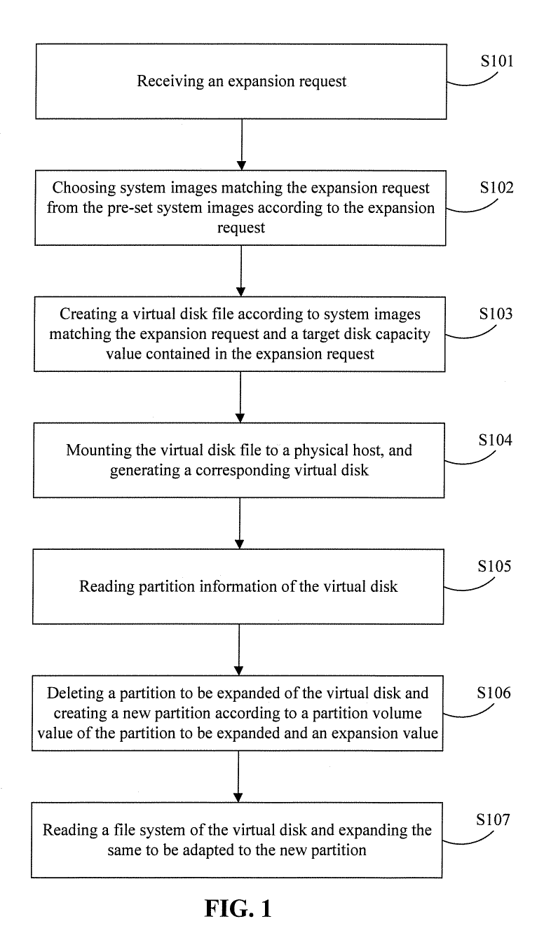

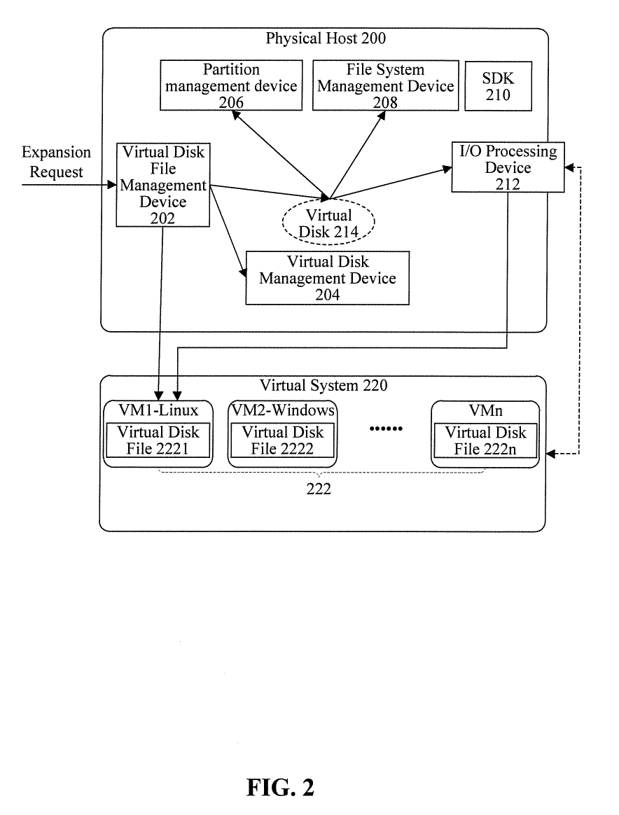

With reference to FIG. 1, a flow chart of an exemplary virtual disk expansion method provided by embodiments of the disclosure is shown. And with reference to FIG. 2, a schematic view of an exemplary virtual disk expansion system provided by the embodiment is shown. The virtual disk expansion method can include steps S101-S107.

In step S101, an expansion request can be received.

The virtual disk expansion method provided by the present disclosure is realized on a physical host. An expansion process of the virtual disk expansion method does not need to initiate a virtual machine on the physical host. Expanding to the virtual disk before the initiating of the virtual machine does not need to start a virtual machine on a physical host, thereby reducing the complexity and coupling of the expansion process. Moreover, when compared with the expansion in an operating system installed on a virtual machine after the start of the virtual machine, the disclosed embodiments avoid the execution of an I/O request in the operating system, shorten the I/O path, reduce consumption of the I/O path, and improve the I/O efficiency.

In actual applications, due to the variability of users' actual service demands, their demands for virtual disks are also flexible. Therefore, once a volume value of a virtual disk chosen by a user is greater than a default volume value of a pre-set virtual disk, the expansion request is triggered. For example, when a default volume value of a virtual disk is 500 G and a volume value of a virtual disk actually chosen by a user is 2 T, an expansion request is triggered and a default virtual disk is expanded. The expansion request contains a target disk volume value, which is a volume value of a virtual disk actually chosen by the user (e.g., a target disk volume value actually chosen by the user is 2 T).

In step S102, system images matching the expansion request from the pre-set system images according to the expansion request can be chosen.

This step of choosing system images matching the expansion request from the pre-set system images according to the expansion request, for example, can follow the above step S101 of receiving the expansion request. If the expansion request contains an operating system type, the system images matching the expansion request correspondingly comprise system images having an operating system type being consistent with the operating system type contained in the expansion request. For example, if the operating system type contained in the expansion request is identified as Linux™, an operating system type corresponding to a first system image can be Linux™, and an operating system type corresponding to a second system image can be Windows™, then the first system image matches the expansion request.

Besides, the system images matching the expansion request can further satisfy a volume value of a corresponding virtual disk being smaller than the target disk volume value. For example, if the target disk volume value contained in the expansion request is 2 T, a volume value of a virtual disk corresponding to a third system image is 1 T and a volume value of a virtual disk corresponding to a fourth system image is 5 T, then the third system image matches the expansion request.

Alternatively, the system images matching the expansion request can further satisfy the condition of system images with a difference value between the volume value of the corresponding virtual disk and the target disk volume value being within a pre-set threshold range. For example, if the target disk volume value contained in the expansion request is 2 T, a volume value of a virtual disk corresponding to a fifth system image is 500 GT and a volume value of a virtual disk corresponding to a sixth system image is 1 T, then the sixth system image matches the expansion request to the extent that it is within the pre-set threshold range.

In step S103, a virtual disk file according to system images matching the expansion request and a target disk volume value contained in the expansion request can be created.

In some embodiments, the virtual disk can be created based on system images. The system images can be provided by the cloud provider for various operating system platforms. For example, a volume value of a virtual disk corresponding to system images provided for a Linux system is 500 G, and a volume value of a virtual disk corresponding to system images provided for a Windows system is 1 T.

The virtual disk file logically represents a virtual disk. However, because the virtual machine is not started yet, the virtual disk file cannot be presented in a form of a virtual disk, but can be stored in a form of a file.

In this step S103, a corresponding virtual disk file is created according to the target disk volume value contained in the received expansion request, and the system images create the corresponding virtual disk file. That is, it logically represents the virtual disk file of a virtual disk created by the system images.

With regard to a virtual disk expansion system shown in FIG. 2, the virtual disk expansion method of the present disclosure is realized based on the virtual disk expansion system. The virtual disk expansion system comprises a physical host 200 and a virtual system 220. The physical host 200 represents an apparatus logically belonging to a physical host, comprising a virtual disk file management device 202, a virtual disk management device 204, a partition management device 206, a file system management device 208, a Software Development Kit (SDK) 210, and an I/O processing device 212. Virtual system 220 represents an apparatus logically belonging to a virtual system (e.g., a part of the virtual machine that is actually running).

Virtual disk file management device 202 of physical host 200 can be used for receiving and processing a virtual disk file creating request, a deleting request, and an expansion request sent by a user, and is used as an entrance for the life cycle management of the virtual disk file in actual applications. After virtual disk file management device 202 receives the expansion request, a corresponding virtual disk file is created according to the target disk volume value contained in the expansion request and the system images. In this step, the virtual disk file being created according to the target disk volume value and the system images is realized based on virtual disk file management device 202.

Virtual disk management device 204 is responsible for managing the creation and cleaning of virtual disks. After a virtual disk corresponding to the virtual disk file is created in the virtual disk management device 204, the created virtual disk is expanded based on an encapsulation interface provided by the SDK 210 and in conjunction with partition management device 206 and file system management device 208.

Partition management device 206 is used for performing management operations (such as checking, adding, deleting and attribute configuration) on all the partitions of the virtual disk.

File system management device 208 is used for performing management operations (such as checking, repairing, expanding and metadata checking) on a file system of the virtual disk.

SDK 210 encapsulates a series of interfaces for virtual disk, partition management, and file system management involved in the virtual disk expansion process. And logics of various virtualization platforms, partition type, and file system are hidden inside a series of function interfaces. The internal implementation of the function interfaces involves passing parameters corresponding to various function interfaces via various binary tools and then returning a corresponding function interface calling result. Various interfaces encapsulated by SDK 210 will be described in detail respectively below.

I/O processing device 212 is responsible for processing the I/O requests, so as to ensure that the I/O requests are completed correctly. For example, I/O requests generated during the expansion process will be sent to I/O processing device 212 to be processed.

In step S104, the virtual disk file can be mounted to a physical host, and a corresponding virtual disk can be generated.

As stated above, the virtual disk file created in the above step S103 logically represents a virtual disk. And in this step S104, virtualization processing is performed on the virtual disk file based on the virtualization platform, and the virtual disk file turns into a virtual disk after virtualization processing.

In some embodiments, this step S104 can be carried out in virtual disk management device 204. As shown in FIG. 2, virtual disk management device 204 in the virtual disk expansion system mounts the virtual disk file to the physical host by calling a pre-set mounting interface. The physical host itself parses the virtual disk file, reads virtual disk information recorded in the virtual disk file, and generates a virtual disk according to the read virtual disk information (e.g., a virtual disk corresponding to the virtual disk file). The mounting interface is provided by SDK 210, and respective mounting tools of virtualization platforms encapsulated by SDK 210 can be used via the mounting interface for mounting a virtual disk file 222 of virtual system 220 in FIG. 2. Virtual system 220 can include a plurality of virtual machines such as virtual machine VM1-Linux, VM2-Windows, . . . , and VMn. The plurality of virtual machines can respectively include a plurality of virtual disks 222, such as a virtual disk 2221, a virtual disk 2222, . . . , a virtual disk 222n. The virtualization platforms comprise, for example, Xen and KVM.

For example, SDK 210 encapsulates an attach tool of a virtualization component xend of the virtualization platform Xen and an NBD attach tool of a virtualization component QEMU of the virtualization platform KVM, and provides block_attach ( ) and block_detach ( ) function interfaces. In some embodiments, a virtual disk file is mounted to a physical host by calling the block_attach ( ) interface, and a virtualization component corresponding to the virtualization platform creates a virtualization block device.

Furthermore, other than the above two virtualization platforms, virtualization components of other virtualization platforms can be further encapsulated in SDK 210, so that the corresponding virtual disk can be created on multiple virtualization platforms according to the virtual disk file. Based on this, SDK 210 can be compatible with different virtualization platforms and has a stronger compatibility.

As stated above, the virtual disk created in virtual disk management device 204 can be used by partition management device 206 and file system management device 208. Therefore, I/O activities transmitted by I/O processing device 212 are hidden between the virtual disk and the virtual disk file, and partition management device 206 and file system management device 208 do not need to contact I/O processing device 212, thereby reducing the complexity.

In step S105, partition information of the virtual disk can be read.

In this step, based on the virtual disk created in the above step S104 (e.g., the virtual disk corresponding to the virtual disk file), partition information of the virtual disk is read.

In some embodiments, as illustrated in FIG. 2, partition management device 206 in the virtual disk expansion system acquires partition information recorded in the virtual disk file by calling a pre-set partition acquisition interface, as partition information of the virtual disk. The partition acquisition interface is provided by SDK 210. SDK 210 encapsulates a partition information acquisition command provided by a partition tool. The partition information is used via the partition acquisition interface provided by SDK 210. For example, partition information recorded in the virtual disk file is read therefrom via a part_get ( ) interface, as the partition information of the virtual disk.

Besides, SDK 210 further encapsulates other commands (e.g., adding, deleting, and attribute setting commands) provided by the partition tool. Based on this, SDK 210 provides function interfaces (e.g., part_add ( ), part_del ( ) and part_set ( )) for performing operations (e.g., adding, deleting, and attribute setting) on partitions of the virtual disk.

In embodiments of the present disclosure, the partition information can include the number of partitions, a partition identifier, start sector position information, end sector position information, a flag, and a partition type. For example, when a virtual disk has only one partition, the number of partitions is 1, the partition identifier is P1, the start sector position information is a sector corresponding to sector number SectorS, the end sector position information is a sector corresponding to sector number SectorE, the flag is Flag1, and the partition type is Type1.

In some embodiments, after this step S105 is executed, that is, after the partition information of the virtual disk is read, the following expansion check operation can be further executed according to the read partition information, to check whether partitions of the virtual disk can be expanded, and the expansion check operation can include: determining, according to the partition information, whether partitions of the virtual disk satisfy an expansion condition; if the partitions of the virtual disk satisfy the expansion condition, step S106 (to be described) can be executed; and if the partitions of the virtual disk do not satisfy the expansion condition, reminding information of expansion error can be sent.

In these embodiments, the expansion condition can include the partition volume value of the partition to be expanded being greater than or equal to the target disk volume value, and the partition type of the virtual disk supporting expansion. Besides, the expansion condition can be further set according to actual applications and is not limited to the above. For example, the expansion condition can further include the partition volume value of the partition to be expanded being greater than or equal to the target disk volume value, or the partition type of the virtual disk supporting expansion.

In step S106, a partition to be expanded of the virtual disk can be deleted and a new partition can be created according to a partition volume value of the partition to be expanded and an expansion value.

In these embodiments, when the virtual disk is expanded, a certain partition of the virtual disk is chosen for expansion, so that a volume value of the expanded virtual disk is equal to the target disk volume value. Similarly, two or more partitions of the virtual disk can be further expanded, so that a volume value of the expanded virtual disk is equal to the target disk volume value. For example, when the target disk volume value is 2 T, and the virtual disk has five partitions, with the partition volume value of each partition being 100 G, each partition is expanded from 100 G to 400 G, so that the volume value of the expanded virtual disk reaches 2 T.

In embodiments of the present disclosure, the expansion value refers to a difference value between the target disk volume value and a disk volume value of the virtual disk created according to the system images. For example, when the target disk volume value is 2 T and the volume value of the virtual disk is 500 G, the expansion value is 2 T−500 G=1.5 T.

The partition volume value is obtained by calculation according to the start sector position information and the end sector position information. For example, with regard to the above partition P1, the start sector position information is a sector corresponding to sector number SectorS, the end sector position information is a sector corresponding to sector number SectorE, then the partition volume value is a total volume value of all the sectors from sector number SectorS to sector number SectorE.

In these embodiments, the expansion process is described in detail by taking the implementation of expanding one partition of the virtual disk as an example. Besides, the implementation of expanding two or more partitions of the virtual disk is similar to that of expanding one partition of the virtual disk, and details are not repeatedly described herein.

In this embodiment, the expansion process can include:

1) Choosing the partition to be expanded from partitions of the virtual disk, and storing partition information corresponding to the partition to be expanded.

For example, the above partition P1 is chosen as a partition to be expanded, and the partition identifier P1, the sector number SectorS, the sector number SectorE, the flag Flag1 and the partition type Type1 of the partition to be expanded P1 are recorded.

2) Deleting the partition to be expanded.

In some embodiments, the partition to be expanded is deleted from the virtual disk file by calling a pre-set partition deleting interface, wherein the partition deleting interface is provided by SDK 210, and a partition deleting command provided by the partition tool is used via the partition deleting interface, for example, a part_del ( ) interface is called to delete the partition P1.

3) Creating the new partition according to the stored partition information, the partition volume value of the partition to be expanded and the expansion value.

When the new partition is being created, a partition identifier and a partition type of the new partition correspond to partition information of the partition to be expanded, to ensure partition consistency before and after the expansion, and also to ensure virtual disk consistency before and after the expansion.

In addition, when the new partition is being created, start sector position information of the new partition correspond to start sector position information of the partition to be expanded, and end sector position information of the new partition is obtained according to the start sector position information of the partition to be expanded and the expansion value.

For example, the partition identifier of the new partition is P1, the start sector position information is: a sector corresponding to sector number SectorS, the end sector position information is: a sector corresponding to sector number SectorE+1.5 T=a sector corresponding to sector number SectorF, and the partition type is Type1.

In some embodiments, the new partition is created in the virtual disk file by calling a pre-set partition creating interface, wherein the partition creating interface is provided by SDK 210, and a partition creating command provided by the partition tool is used via the partition creating interface. For example, a part_add ( ) interface is called to create a new partition P1.

4) setting the new partition according to the stored partition information.

In some embodiments, the new partition is set in the virtual disk file by calling a pre-set partition setting interface, wherein the partition setting interface is provided by SDK 210, and a partition setting command provided by the partition tool is used via the partition setting interface. For example, a part_set ( ) interface is called to set the flag of the new partition P1 as Flag1.

For example, the expansion process can be realized by using a variety of specific implementations. Various form changes for realizing the expansion process are only changes to specific implementations, and are all within the scope of protection of the present disclosure without departing from the core of the present disclosure.

In step S107, a file system of the virtual disk can be read and the file system can be expanded to be adapted to the new partition.

In the above step S106, the virtual disk is expanded by deleting the partition to be expanded and creating the new partition, but no mapping is established between the newly-created new partition and the original file system of the virtual disk. In this step S107, a file system of the virtual disk is read and expanded to be adapted to the new partition, and this step S107 can further include:

1) reading a file system of the virtual disk from the system images; and

2) calling a pre-set file system expansion interface to expand the file system according to the new partition;

The file system expansion interface is provided by SDK 210, and an expansion tool of a file system tool set encapsulated by SDK 210 is used via the file system expansion interface. For example, an fs_extend ( ) interface is called to expand the file system of the virtual disk.

In some embodiments, after the sub-step of reading a file system of the virtual disk from the system images is executed, and before the sub-step of calling a pre-set file system expansion interface to expand the file system according to the new partition is executed, the following file system check operation can be further executed. The file system check operation can further include: calling, with reference to a partition type of the partition to be expanded, a pre-set file system check interface to check whether the file system is valid (e.g., the file system is complete); if the file system is valid, executing the above sub-step of calling a pre-set file system expansion interface to expand the file system according to the new partition, and if the file system is not valid, calling a pre-set file system repairing interface to repair the file system; calling, with reference to a partition type of the partition to be expanded, the file system check interface to check whether the file system is repaired, and if the file system is repaired, executing the sub-step of calling a pre-set file system expansion interface to expand the file system according to the new partition, wherein the file system check interface is provided by SDK 210, and a check tool of a file system tool set encapsulated by SDK 210 is used via the file system check interface. For example, an fs_check ( ) interface is called to check the file system of the virtual disk.

The file system repairing interface is provided by SDK 210, and a repairing tool of a file system tool set encapsulated by SDK 210 is used via the file system repairing interface. For example, an fs_fix ( ) interface is called to repair the file system of the virtual disk.

In addition, after the sub-step of calling a pre-set file system expansion interface to expand the file system according to the new partition is executed, the following file system second check operation can be further executed. The file system second check operation can further include: calling, with reference to a partition type of the partition to be expanded, the file system check interface to check whether the file system is valid; if the file system is valid, indicating that the file system of the virtual disk is expanded successfully and performing no processing, and if the file system is not valid, sending reminding information of expansion failure.

In some embodiments, after this step S107 is executed (e.g., the expansion of the file system of the virtual disk is completed), the following virtual disk cleaning operation can be further executed on the virtual disk created in the above step S104 to clean the virtual disk, so as to reserve system resources and improve system performance. The virtual disk cleaning operation can at least include: calling a pre-set cleaning interface to clean the virtual disk, wherein the cleaning interface is provided by SDK 210, and respective cleaning tools of the virtualization platforms encapsulated by SDK 210 can be used via the cleaning interface for cleaning the virtual disk. For example, a block_detach ( ) interface is called to clean the virtual disk.

In summary, the virtual disk expansion method provided by the present disclosure involves: after an expansion request is received, creating a virtual disk file according to a target disk volume value contained in the expansion request and pre-set system images; mounting the virtual disk file to a physical host, and generating a virtual disk corresponding to the virtual disk file; reading partition information of the virtual disk; deleting a partition to be expanded of the virtual disk and creating a new partition according to the read partition information; and reading a file system of the virtual disk and expanding the file system to be adapted to the newly-created new partition. The virtual disk expansion method can be realized based on a physical host for the virtual disk expansion, therefore the I/O path can be shortened, consumption of the I/O path can be reduced, and the I/O efficiency can be improved. In addition, with regard to the virtual disk expansion method, during the virtual disk expansion process, there is no need to start a virtual machine on the physical host and the expansion to the virtual disk is performed before the start of the virtual machine, thereby reducing technical complexity and coupling. The implementation of the method is quite simple.

Embodiments of a virtual disk expansion apparatus provided by the present disclosure is described as below.

In the above embodiments, a virtual disk expansion method is provided, and correspondingly, the present disclosure further provides a virtual disk expansion apparatus, which will be described in conjunction with the figure.

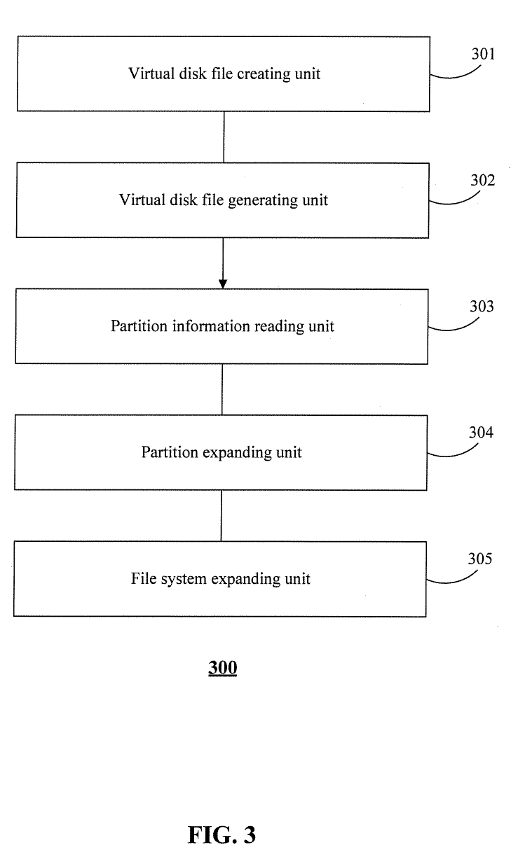

With reference to FIG. 3, a schematic view of an exemplary virtual disk expansion apparatus according to embodiments of the present disclosure is shown.

Embodiments of the apparatus are described relatively simply because they are substantially similar to the embodiments of the method, and for the relevant parts, references may be made to the corresponding descriptions of the embodiments of the method. The following embodiments of the apparatus are exemplary only.

The present disclosure provides a virtual disk expansion apparatus 300, including a virtual disk file creating unit 301, a virtual disk generating unit 302, a partition information reading unit 303, a partition expanding unit 304, and a file system expanding unit 305.

Virtual disk file creating unit 301 can be used to create a virtual disk file according to pre-set system images and a target disk volume value contained in a received expansion request. Virtual disk file creating unit 301 can be part of virtual disk file management device 202, described above in FIG. 2. For example, after receiving the expansion request, virtual disk file management device 202 can provide the target disk volume value and information related to the pre-set system images to virtual disk file creating unit 301 for creating virtual disk file 222 of FIG. 2.

The expansion request can contain an operating system type; correspondingly, the system images matching the expansion request comprise system images with an operating system type being consistent with the operating system type contained in the expansion request.

In some embodiments, the system images matching the expansion request can include: system images having a volume value of a virtual disk being smaller than the target disk volume value, or system images having a difference value between the volume value of the virtual disk and the target disk volume value being within a pre-set threshold range.

Virtual disk generating unit 302 can be used to mount virtual disk file 222 to a physical host and generate a corresponding virtual disk 214. Virtual disk generating unit 302 can be part of SDK 210, which can provide respective mounting tools of virtualization platforms encapsulated by SDK 210 for mounting virtual disk file 222 of virtual system 220 as discussed with reference to FIG. 2.

In some embodiments, virtual disk generating unit 302 can be realized by calling a pre-set mounting interface, wherein the mounting interface is provided by a pre-set SDK, and respective mounting tools of virtualization platforms encapsulated by the SDK are used via the mounting interface for achieving the mounting of a virtual disk file, the virtualization platforms comprise: Xen and KVM.

Partition information reading unit 303 can be used to read partition information of virtual disk 214. Partition information reading unit 303 can be part of partition management device 206. For example, partition management device 206 can acquire the partition information recorded in the virtual disk file by calling a pre-set partition acquisition interface as described above in FIG. 2.

In some embodiments, partition information reading unit 303 can be used to call a pre-set partition acquisition interface to acquire partition information recorded in the virtual disk file to be taken as partition information of the virtual disk, wherein the partition acquisition interface is provided by a pre-set SDK, and a partition information acquisition command provided by a partition tool encapsulated by the SDK is used via the partition acquisition interface.

The partition information can, for example, include: the number of partitions, a partition identifier, start sector position information, end sector position information, a flag, and a partition type.

Partition expanding unit 304 can be used to delete a partition to be expanded of the virtual disk and create a new partition according to a partition volume value of the partition to be expanded and an expansion value. Partition expanding unit 304 can involve part of partition management device 206, file system management device 208, and SDK 210. For example, as described in FIG. 2, after the virtual disk corresponding to the virtual disk file is created in the virtual disk management device 204, the created virtual disk is expanded based on an encapsulation interface provided by SDK 210 and in conjunction with partition management device 206 and file system management device 208.

The expansion value can be a difference value between the target disk volume value and a disk volume value of the virtual disk created according to the system images.

The partition volume value can be obtained by calculation according to the start sector position information and the end sector position information.

In some embodiments, partition expanding unit 304 can further include: a partition to be expanded selecting sub-unit, a partition to be expanded deleting sub-unit, a new partition creating sub-unit, and a new partition setting sub-unit.

The partition to be expanded selecting sub-unit can be used to select a partition to be expanded from partitions of the virtual disk and store partition information corresponding to the partition to be expanded.

The partition to be expanded deleting sub-unit can be used to delete the partition to be expanded.

The new partition creating sub-unit can be used to create the new partition according to the stored partition information, the partition volume value of the partition to be expanded and the expansion value.

And the new partition setting sub-unit can be used to set the new partition according to the stored partition information.

Optionally, a partition identifier of the partition to be expanded can be consistent with a partition identifier, a flag, and/or a partition type of the new partition.

In some embodiments, start sector position information of the partition to be expanded can be consistent with start sector position information of the new partition, and end sector position information of the new partition can be obtained according to the start sector position information and the expansion value of the partition to be expanded.

Optionally, the partition to be expanded deleting sub-unit can be further used to call a pre-set partition deleting interface to delete the partition to be expanded from the virtual disk file, wherein the partition deleting interface is provided by the SDK, and a partition deleting command provided by the partition tool is used via the partition deleting interface.

Optionally, the new partition creating sub-unit can be further used to call a pre-set partition creating interface to create the new partition in the virtual disk file, wherein the partition creating interface is provided by the SDK, and a partition creating command provided by the partition tool is used via the partition creating interface.

In some embodiments, the new partition setting sub-unit can be further used to call a pre-set partition setting interface to set the new partition in the virtual disk file according to the stored partition information, wherein the partition setting interface can be provided by the SDK, and a partition setting command provided by the partition tool can be used via the partition setting interface.

File system expanding unit 305 can be used to read a file system of the virtual disk and expand the file system to be adapted to the new partition. File system expanding unit 305 can be part of file system management device 208. For example, as discussed in FIG. 2, file system management device 208 can be used for performing management operations (e.g., expanding) on a file system of the virtual disk.

In some embodiments, file system expanding unit 305 can further include: a file system reading sub-unit and a file system expanding sub-unit.

The file system reading sub-unit can be used to read a file system of the virtual disk from the system images, and the file system expanding sub-unit can be used to call a pre-set file system expansion interface to expand the file system according to the new partition.

In some embodiments, file system expanding unit 305 further include: a file system checking sub-unit.

The file system checking sub-unit can be used to call, with reference to a partition type of the partition to be expanded, a pre-set file system check interface to check whether the file system is valid, and if the file system is valid, running the file system expanding sub-unit, wherein the file system check interface is provided by the SDK, and a check tool of a file system tool set encapsulated by the SDK is used via the file system check interface.

If a determining result input by the file system checking sub-unit is negative, a file system repairing sub-unit and a repair check sub-unit can be run.

The file system repairing sub-unit can be used to call a pre-set file system repairing interface to repair the file system. And the repair check sub-unit can be used to call, with reference to a partition type of the partition to be expanded, the file system check interface to check whether the file system is repaired, and if the file system is repaired, the file system expanding sub-unit is executed, wherein the file system repairing interface is provided by the SDK, and a repairing tool of a file system tool set encapsulated by the SDK is used via the file system repairing interface.

In some embodiments, file system expanding unit 305 can further include: a second check sub-unit, for calling, with reference to a partition type of the partition to be expanded, the file system check interface to check whether the file system is valid, and if the file system is not valid, sending reminding information of expansion failure.

In general, the units used herein (and any corresponding sub-units), can be a packaged functional hardware unit designed for use with other components (e.g., portions of an integrated circuit), a part of a program (stored on a computer readable medium) that performs a particular function of related functions, or a combination thereof. The units can have entry and exit points and can be written in a programming language, such as, for example, Java, Lua, C or C++. A software unit can be compiled and linked into an executable program, installed in a dynamic link library, or written in an interpreted programming language such as, for example, BASIC, Perl, or Python. It will be appreciated that software units can be callable from other units or from themselves, and/or can be invoked in response to detected events or interrupts. Software units configured for execution on computing devices can be provided on a computer readable medium, such as a compact disc, digital video disc, flash drive, magnetic disc, or any other non-transitory medium, or as a digital download (and can be originally stored in a compressed or installable format that requires installation, decompression, or decryption prior to execution). Such software code can be stored, partially or fully, on a memory device of the executing computing device, for execution by the computing device. Software instructions can be embedding in firmware, such as an EPROM. It will be further appreciated that hardware units can be comprised of connected logic units, such as gates and flip-flops, and/or can be comprised of programmable units, such as programmable gate arrays or processors. The units or computing device functionality described herein are preferably implemented as software modules, but can be represented in hardware or firmware. Generally, the units described herein refer to logical units that can be combined with other units or divided into sub-units despite their physical organization or storage.

In some embodiment, virtual disk expansion apparatus 300 can further include: an expansion request receiving unit, for receiving an expansion request.

In some embodiment, virtual disk expansion apparatus 300 can further include: a virtual disk cleaning unit for calling a pre-set cleaning interface to clean the virtual disk, wherein the cleaning interface is provided by the SDK, and respective cleaning tools of the virtualization platforms encapsulated by the SDK are used via the cleaning interface for cleaning the virtual disk.

Optionally, virtual disk expansion apparatus 300 can further include: an expansion determining unit, for determining, according to the partition information, whether partitions of the virtual disk satisfy an expansion condition, and if the partitions of the virtual disk satisfy the expansion condition, running partition expanding unit 304.

Optionally, the expansion condition can include: the partition volume value of the partition to be expanded being greater than or equal to the target disk volume value, and/or the partition type of the virtual disk supporting expansion.

Embodiments of an electronic device provided by the present disclosure will be described in conjunction with the figure.

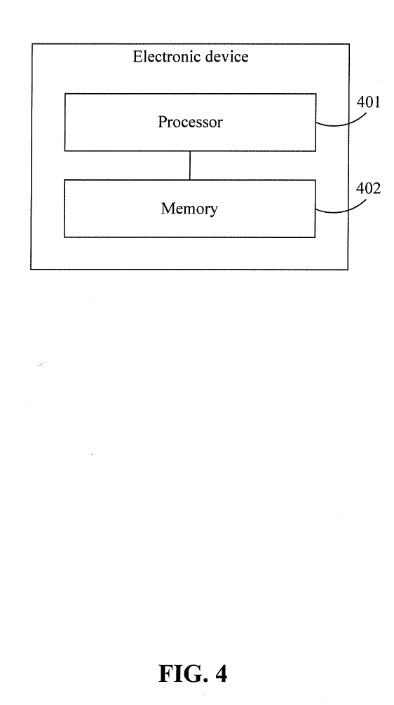

With reference to FIG. 4, a schematic view of an exemplary electronic device provided by embodiments of the present disclosure is illustrated.

Embodiments of the electronic device are described relatively simply because they are substantially similar to the embodiments of the method, and for the relevant part, reference may be made to the corresponding descriptions of the embodiments of the method. The following embodiments are exemplary only.

The present disclosure provides an electronic device, comprising a processor 401 and a memory 402. Processor 401 can be used for creating a virtual disk file according to pre-set system images and a target disk volume value contained in a received expansion request.

In some embodiments, before executing the step of creating a virtual disk file according to pre-set system images and a target disk volume value contained in a received expansion request, processor 401 can execute the step of acquiring the expansion request. Optionally, after executing the step of acquiring the expansion request, processor 401 can execute the step of choosing system images matching the expansion request from the pre-set system images according to the expansion request.

In some embodiments, the expansion request contains an operating system type; correspondingly, the system images matching the expansion request comprise system images with an operating system type being consistent with the operating system type contained in the expansion request. The system images matching the expansion request can include system images having a volume value of a corresponding virtual disk being smaller than the target disk volume value, or system images having a difference value between the volume value of the corresponding virtual disk and the target disk volume value being within a pre-set threshold range.

Moreover, processor 401 can be used to mount the virtual disk file to a physical host, and generate a virtual disk. Mounting the virtual disk file to a physical host can be realized by calling a pre-set mounting interface, wherein the mounting interface is provided by a pre-set SDK, and respective mounting tools of virtualization platforms encapsulated by the SDK are used via the mounting interface for mounting a virtual disk file, the virtualization platforms can comprise Xen and KVM.

After executing the step of reading a file system of the virtual disk and expanding the file system to be adapted to the new partition, processor 401 can execute the step of calling a pre-set cleaning interface to clean the virtual disk. The pre-set cleaning interface can be provided by the SDK. The cleaning interface cab use a respective cleaning tool, for cleaning the virtual disk. The respective cleaning tool can be part of the virtualization platforms encapsulated by the SDK.

Processor 401 can be used to read partition information of the virtual disk, delete a partition to be expanded of the virtual disk and create a new partition according to a partition volume value and an expansion value of the partition to be expanded. In some embodiments, the reading partition information of the virtual disk is realized by calling a pre-set partition acquisition interface to acquire partition information recorded in the virtual disk file to be taken as partition information of the virtual disk. The partition acquisition interface can be provided by a pre-set SDK. The partition acquisition interface can use a partition information acquisition command provided by a partition tool encapsulated by the SDK. The partition information can include the number of partitions, a partition identifier, start sector position information, end sector position information, a flag, and a partition type.

The expansion value can be a difference value between the target disk volume value and a disk volume value of the virtual disk created according to the system images.

In some embodiments, the partition volume value can be obtained by calculation according to the start sector position information and the end sector position information.

After executing the step of reading partition information of the virtual disk and before executing the step of deleting a partition to be expanded of the virtual disk and creating a new partition according to a partition volume value of the partition to be expanded and an expansion value, processor 401 can execute the step of determining, according to the partition information, whether partitions of the virtual disk satisfy an expansion condition, and if the virtual disk satisfy the expansion condition, executing the next step.

The expansion condition can include: the partition volume value of the partition to be expanded being greater than or equal to the target disk volume value, and/or the partition type of the virtual disk supporting expansion.

The step of deleting a partition to be expanded of the virtual disk and creating a new partition according to a partition volume value of the partition to be expanded and an expansion value can further include: choosing the partition to be expanded from partitions of the virtual disk, and storing partition information corresponding to the partition to be expanded; deleting the partition to be expanded; creating the new partition according to the stored partition information, the partition volume value of the partition to be expanded and the expansion value; and setting the new partition according to the stored partition information.

A partition identifier of the partition to be expanded can be consistent with a partition identifier, a flag, and/or a partition type of the new partition.

Start sector position information of the partition to be expanded can be consistent with start sector position information of the new partition. And end sector position information of the new partition can be obtained by calculation according to the start sector position information of the partition to be expanded and the expansion value.

In some embodiments, the deleting the partition to be expanded can be realized by calling a pre-set partition deleting interface to delete the partition to be expanded from the virtual disk file, wherein the partition deleting interface can be provided by the SDK, and a partition deleting command provided by the partition tool can be used via the partition deleting interface.

In some embodiments, the creating the new partition can be realized by: calling a pre-set partition creating interface to create the new partition in the virtual disk file, wherein the partition creating interface can be provided by the SDK, and a partition creating command provided by the partition tool can be used via the partition creating interface.

In some embodiments, the setting the new partition according to the stored partition information can be realized by calling a pre-set partition setting interface to set the new partition in the virtual disk file according to the stored partition information, wherein the partition setting interface can be provided by the SDK, and a partition setting command provided by the partition tool can be used via the partition setting interface.

Processor 401 can be used to read a file system of the virtual disk and expand the file system to be adapted to the new partition. In some embodiments, the step of reading a file system of the virtual disk and expanding the file system to be adapted to the new partition can include: reading a file system of the virtual disk from the system images, and calling a pre-set file system expansion interface to expand the file system according to the new partition, wherein the file system expansion interface can be provided by the SDK, and an expansion tool of a file system tool set encapsulated by the SDK can be used via the file system expansion interface.

In some embodiments, after the sub-step of reading a file system of the virtual disk from the system images is executed and before the sub-step of calling a pre-set file system expansion interface to expand the file system according to the new partition is executed, the following sub-step can be executed: calling, with reference to a partition type of the partition to be expanded, a pre-set file system check interface to check whether the file system is valid, and if the file system is valid, executing the next step, wherein the file system check interface is provided by the SDK, and a check tool of a file system tool set encapsulated by the SDK is used via the file system check interface.

With regard to the sub-step of calling, with reference to a partition type of the partition to be expanded, a pre-set file system check interface to check whether the file system is valid. If the file system is not valid, the following sub-step can be executed: calling a pre-set file system repairing interface to repair the file system; and calling, with reference to a partition type of the partition to be expanded, the file system check interface to check whether the file system is repaired, and if the file system is repaired, executing the sub-step of calling a pre-set file system expansion interface to expand the file system according to the new partition, wherein the file system repairing interface is provided by the SDK, and a repairing tool of a file system tool set encapsulated by the SDK is used via the file system repairing interface.

After the sub-step of calling a pre-set file system expansion interface to expand the file system according to the new partition is executed, the following sub-step can be executed: calling, with reference to a partition type of the partition to be expanded, the file system check interface to check whether the file system is valid, and if the file system is not valid, sending reminding information of expansion failure.

Memory 402 can be used to store the virtual disk file, the partition information of the virtual disk, and the file system of the virtual disk.

The present disclosure is disclosed with reference to the above embodiments which are, however, not to limit the present disclosure. Any person skilled in the art may, without departing from the spirit and scope of the present disclosure, make possible variations or modifications, and therefore the scope of protection of the present disclosure shall be defined by the scope of protection defined by the claims.

In a typical configuration, a computing device includes one or more processors (CPUs), an input/output interface, a network interface, and a memory.

The memory may include a non-permanent memory, a random-access memory (RAM) and/or a non-volatile memory (such as a read-only memory (ROM) or a flash memory (flash RAM)), and so on in computer-readable media. The memory is an example of the non-transitory computer-readable media.

The computer-readable media can include permanent and non-permanent, removable and non-removable media and may realize information storage with any method or technology. The information may be a computer-readable instruction, object, program module or other data. Common forms of non-transitory computer-readable media include, for example, a phase change memory (PRAM), static random access memory (SRAM), dynamic random access memory (DRAM), other types of random access memories (RAMs), read-only memory (ROM), electrically erasable programmable read-only memory (EEPROM), flash memory or other memory technologies, compact disk read-only memory (CD-ROM), digital versatile disc (DVD) or other optical storage, a cache, a register, magnetic cassette tape, magnetic tape and magnetic disk storage or other magnetic storage devices, networked versions of the same, or any other non-transmission media, which can be used to store information that can be accessed by a computing device. According to the definition herein, the computer-readable media do not include transitory media, such as modulated data signals and carriers.

It should be understood by a person skilled in the art that the embodiments of the present disclosure may be provided as methods, systems or computer program products. Thus, the present disclosure may adopt full hardware embodiments, full software embodiments, or embodiments which combine software and hardware. Moreover, the present disclosure may be embodied by computer program products implemented on one or more computer-usable storage media (including but not limited to magnetic disk memories, CD-ROM, optical memories and so on) containing computer-usable program codes.

1. A virtual disk expansion method, comprising:
creating a virtual disk file according to system images and a target disk volume value contained in a received expansion request;
mounting the virtual disk file to a physical host, and generating a virtual disk;
reading partition information of the virtual disk;
deleting a partition to be expanded of the virtual disk and creating a new partition according to a partition volume value of the partition to be expanded and an expansion value; and
reading a file system of the virtual disk and expanding the file system to be adapted to the new partition.

2. The virtual disk expansion method according to claim 1, further comprising:
receiving the expansion request; and
choosing system images matching the expansion request from the system images according to the expansion request.

3. The virtual disk expansion method according to claim 2, wherein the expansion request contains an operating system type; and the system images matching the expansion request comprise system images having an operating system type consistent with the operating system type contained in the expansion request.

4. The virtual disk expansion method according to claim 2, wherein the system images matching the expansion request comprise:
system images having a volume value of a virtual disk being smaller than the target disk volume value, or system images having a difference value between the volume value of the corresponding virtual disk and the target disk volume value being within a threshold range.

5. The virtual disk expansion method according to claim 1, wherein mounting the virtual disk file to a physical host is realized by calling a mounting interface, wherein the mounting interface is provided by an SDK, and respective mounting tools of virtualization platforms encapsulated by the SDK are used via the mounting interface for mounting a virtual disk file, the virtualization platforms comprising: Xen and KVM.

6. The virtual disk expansion method according to claim 5, further comprising:
calling a cleaning interface to clean the virtual disk,
wherein the cleaning interface is provided by the SDK, and respective cleaning tools of the virtualization platforms encapsulated by the SDK are used via the cleaning interface for cleaning the virtual disk.

7. The virtual disk expansion method according to claim 1, wherein reading partition information of the virtual disk further comprises:
calling a partition acquisition interface to acquire partition information recorded in the virtual disk file as partition information of the virtual disk,
wherein the partition acquisition interface is provided by an SDK, and a partition information acquisition command provided by a partition tool encapsulated by the SDK is used via the partition acquisition interface.

8. The virtual disk expansion method according to claim 7, wherein the partition information comprises at least one of:
the number of partitions, a partition identifier, start sector position information, end sector position information, a flag, and a partition type.

9. The virtual disk expansion method according to claim 8, wherein the expansion value is a difference value between the target disk volume value and a disk volume value of the virtual disk created according to the system images.

10. The virtual disk expansion method according to claim 8, wherein the partition volume value is obtained according to the start sector position information and the end sector position information.

11. The virtual disk expansion method according to claim 8, further comprising:
determining, according to the partition information, whether partitions of the virtual disk satisfy an expansion condition, and if the partitions of the virtual disk satisfy the expansion condition, executing the next step.

12. The virtual disk expansion method according to claim 11, wherein the expansion condition comprises:
the partition volume value of the partition to be expanded being greater than or equal to the target disk volume value, and/or the partition type of the virtual disk supporting expansion.

13. The virtual disk expansion method according to claim 8, wherein deleting a partition to be expanded of the virtual disk and creating a new partition according to a partition volume value of the partition to be expanded and an expansion value comprises:
choosing the partition to be expanded from partitions of the virtual disk, and storing partition information corresponding to the partition to be expanded;
deleting the partition to be expanded;
creating the new partition according to the stored partition information, the partition volume value of the partition to be expanded and the expansion value; and
setting the new partition according to the stored partition information.

14. The virtual disk expansion method according to claim 13, wherein a partition identifier of the partition to be expanded is consistent with a partition identifier, a flag, and/or a partition type of the new partition.

15. The virtual disk expansion method according to claim 13, wherein start sector position information of the partition to be expanded is consistent with start sector position information of the new partition; and end sector position information of the new partition is obtained according to the start sector position information of the partition to be expanded and the expansion value.

16. The virtual disk expansion method according to claim 13, wherein deleting the partition to be expanded further comprises:
calling a partition deleting interface to delete the partition to be expanded from the virtual disk file, wherein the partition deleting interface is provided by the SDK, and a partition deleting command provided by the partition tool is used via the partition deleting interface.

17. The virtual disk expansion method according to claim 13, wherein creating the new partition further comprises:
calling a partition creating interface to create the new partition in the virtual disk file, wherein the partition creating interface is provided by the SDK, and a partition creating command provided by the partition tool is used via the partition creating interface.

18. The virtual disk expansion method according to claim 13, wherein setting the new partition according to the stored partition information further comprises: calling a partition setting interface to set the new partition in the virtual disk file according to the stored partition information, wherein the partition setting interface is provided by the SDK, and a partition setting command provided by the partition tool is used via the partition setting interface.

19. The virtual disk expansion method according to claim 8, wherein reading a file system of the virtual disk and expanding the file system to be adapted to the new partition comprises:
reading a file system of the virtual disk from the system images; and
calling a file system expansion interface to expand the file system according to the new partition,
wherein the file system expansion interface is provided by the SDK, and an expansion tool of a file system tool set encapsulated by the SDK is used via the file system expansion interface.

20. The virtual disk expansion method according to claim 19, further comprising:
calling, with reference to a partition type of the partition to be expanded, a file system check interface to check whether the file system is valid, and if the file system is valid, executing the next step,
wherein the file system check interface is provided by the SDK, and a check tool of a file system tool set encapsulated by the SDK is used via the file system check interface.

21. The virtual disk expansion method according to claim 20, wherein if the file system is not valid, executing the following sub-steps:
calling a file system repairing interface to repair the file system; and
calling, with reference to a partition type of the partition to be expanded, the file system check interface to check whether the file system is repaired, and if the file system is repaired, executing the sub-step of calling a file system expansion interface to expand the file system according to the new partition,
wherein the file system repairing interface is provided by the SDK, and a repairing tool of a file system tool set encapsulated by the SDK is used via the file system repairing interface.

22. The virtual disk expansion method according to claim 19, further comprising:
calling, with reference to a partition type of the partition to be expanded, the file system check interface to check whether the file system is valid, and if the file system is not valid, sending reminding information of expansion failure.

23. A virtual disk expansion apparatus, comprising:
a virtual disk file creating unit, for creating a virtual disk file according to system images and a target disk volume value contained in a received expansion request;
a virtual disk generating unit, for mounting the virtual disk file to a physical host, and generating a virtual disk;
a partition information reading unit, for reading partition information of the virtual disk;
a partition expanding unit, for deleting a partition to be expanded of the virtual disk and creating a new partition according to a partition volume value and an expansion value of the partition to be expanded; and
a file system expanding unit, for reading a file system of the virtual disk and expanding the file system to be adapted to the new partition.

24. The virtual disk expansion apparatus according to claim 23, further comprising:
an expansion request receiving unit, for receiving the expansion request; and
a system image choosing unit, for choosing system images matching the expansion request from the system images according to the expansion request.

25. The virtual disk expansion apparatus according to claim 23,
wherein the virtual disk generating unit is realized by calling a mounting interface,
wherein the mounting interface is provided by an SDK, and respective mounting tools of virtualization platforms encapsulated by the SDK are used via the mounting interface for mounting a virtual disk file, the virtualization platforms comprising: Xen and KVM.

26. The virtual disk expansion apparatus according to claim 25, further comprising:
a virtual disk cleaning unit, for calling a cleaning interface to clean the virtual disk,
wherein the cleaning interface is provided by the SDK, and respective cleaning tools of the virtualization platforms encapsulated by the SDK are used via the cleaning interface for cleaning the virtual disk.

27. The virtual disk expansion apparatus according to claim 23, wherein the partition information reading unit is further used for calling a partition acquisition interface to acquire partition information recorded in the virtual disk file to be taken as partition information of the virtual disk,
wherein the partition acquisition interface is provided by an SDK, and a partition information acquisition command provided by a partition tool encapsulated by the SDK is used via the partition acquisition interface.

28. A non-transitory computer readable medium that stores a set of instructions that is executable by at least one processor of a virtual disk expansion apparatus to cause the apparatus to perform a virtual disk expansion method, the method comprising:
creating a virtual disk file according to system images and a target disk volume value contained in a received expansion request;
mounting the virtual disk file to a physical host, and generating a virtual disk;
reading partition information of the virtual disk;
deleting a partition to be expanded of the virtual disk and creating a new partition according to a partition volume value and an expansion value of the partition to be expanded; and
reading a file system of the virtual disk and expanding the file system to be adapted to the new partition.

29. The non-transitory computer readable medium according to claim 28, wherein the set of instructions is executable by the at least one processor of the apparatus to cause the apparatus to further perform:
receiving the expansion request; and
choosing system images matching the expansion request from the system images according to the expansion request.

30. The non-transitory computer readable medium according to claim 29, wherein the expansion request contains an operating system type; and the system images matching the expansion request comprise system images having an operating system type consistent with the operating system type contained in the expansion request.

31. The non-transitory computer readable medium according to claim 29, wherein the system images matching the expansion request comprise:
system images having a volume value of a virtual disk being smaller than the target disk volume value, or system images having a difference value between the volume value of the corresponding virtual disk and the target disk volume value being within a threshold range.

32. The non-transitory computer readable medium according to claim 28, wherein the set of instructions is executable by the at least one processor of the apparatus to cause the apparatus to further perform:
calling a mounting interface, wherein the mounting interface is provided by an SDK, and respective mounting tools of virtualization platforms encapsulated by the SDK are used via the mounting interface for mounting a virtual disk file, the virtualization platforms comprising: Xen and KVM.

33. The non-transitory computer readable medium according to claim 32, wherein the set of instructions is executable by the at least one processor of the apparatus to cause the apparatus to further perform:
calling a cleaning interface to clean the virtual disk,
wherein the cleaning interface is provided by the SDK, and respective cleaning tools of the virtualization platforms encapsulated by the SDK are used via the cleaning interface for cleaning the virtual disk.

34. The non-transitory computer readable medium according to claim 28, wherein the set of instructions is executable by the at least one processor of the apparatus to cause the apparatus to further perform:
calling a partition acquisition interface to acquire partition information recorded in the virtual disk file as partition information of the virtual disk,
wherein the partition acquisition interface is provided by an SDK, and a partition information acquisition command provided by a partition tool encapsulated by the SDK is used via the partition acquisition interface.
